(19) United States
(12) Patent Application Publication
(10) Pub. No.: US 2009/0183797 A1
(43) Pub. Date: Jul. 23, 2009

(54) Removing Volatile Vapors From A Storage Vessel

(75) Inventor: Henry T. Hilliard, Jr., Houston, TX (US)

Correspondence Address: STREETS & STEELE, 13831 NORTHWEST FREEWAY, SUITE 355, HOUSTON, TX, 77040, US

(73) Assignee: HILLIARD EMISSION CONTROLS, INC., Houston, TX (US)

(21) Appl. No.: 12/415,746

(22) Filed: Mar. 31, 2009

Related U.S. Application Data
(63) Continuation-in-part of application No. 11/677,425, filed on Feb. 21, 2007.
Application No. 11/677,425 is a continuation of application No. 11/092,466, filed on Mar. 29, 2005, now Pat. No. 7,343,759.

(51) Int. Cl. B65B 31/04; B08B 9/08; B08B 7/04

(52) U.S. Cl. 141/4; 134/37; 134/107; 141/63; 141/37

(57) ABSTRACT

A method and apparatus to remove vapor from a storage tank comprising introducing a stream of gas into the storage tank to cause mixing of the vapor within the tank. The stream of gas is preferably introduced into the storage tank through a gas nozzle that increases the velocity of the gas. Furthermore, the gas nozzle may have a fixed or variable orientation that introduces the stream of gas to flow into a region of the storage tank to prevent retention of the vapor in that region. A mixture of the vapor and the gas is withdrawn from the storage tank through an outlet port and provided to an abatement unit, such as a condenser or burner. Where the abatement device is a condenser, the gas and any uncondensed vapor may be returned to the storage tank through the gas nozzle, or through a second gas nozzle.

### STATEMENT OF RELATED APPLICATIONS

This is a continuation-in-part application depending from and claiming priority to pending U.S. Ser. No. 11/677,425 filed on Feb. 21, 2007, published as U.S. Publication No. 2007/0151290, which is a continuation-in-part application depending from and claiming priority to U.S. Ser. No. 11/092,466 filed on Mar. 29, 2005, now U.S. Pat. No. 7,343,759.

### BACKGROUND OF THE INVENTION

1. Field of the Invention

This invention relates purging tanks and vessels, and more particularly, to methods and apparatus for efficiently removing vapors from tanks and vessels in preparation for inspection, maintenance, cleaning, or demolition.

2. Description of the Related Art

Volatile liquids, such as benzene, petroleum and the like, are often stored in tanks at bulk terminals, refineries and end-user facilities, and transported in tanks aboard barges or ships, tank trucks and rail cars. All such containers shall be referred to herein as liquid storage vessels. While resident in these liquid storage vessels, volatilization of the liquid occurs leaving residual vapors which must be removed before workmen can be permitted to enter the vessel and before the vessel can be used to store a different liquid.

In some cases, such residual vapors are purged by flooding liquid storage vessels with a sufficient volume of water or air to entrain the vapors and carry them out of the vessel. The resulting mixture of diluted vapors, in many cases, is simply emitted to the atmosphere and surrounding water supply where they pollute the environment. Emissions handled in this manner lead to severe environmental hazards. For example, hydrocarbons are a major contributor to the formation of smog, which has been proven to increase respiratory disorders among the population.

In addition to these environmental problems, water-flushing facilities must overcome many economic hurdles. Adequate water for such facilities may be expensive due to limited water resources or to restrictions concerning the discharge, reuse or recycling of the residual flush water. If the water must be reused or recycled, it may require treatment or conditioning to remove contaminants that might pollute the environment or contaminate the next vessel to be flushed.

There have been several attempts to address the problem of removing vapors from storage tanks and collecting the gases that are forced out of the storage tank to recover, reuse or otherwise treat such gases by, for example, burning, cooling, filtering, absorption, adsorption, or other vapor-handling methods. For example, U.S. Pat. No. 5,476,126 shows apparatus and methods for removing vapors from a storage tank by introducing a purge medium, such as CO₂, into the storage vessel and establishing a uniform and continuous stratified interface between the purge medium and the volatile organic compound layer. As the purge medium is continuously fed into the storage tank, the continuous stratified interface moves within the vessel, thereby purging the undiluted volatile vapors from the vessel into an emissions-abatement process where the vapors may, for example, be combusted, adsorbed onto an adsorption bed and/or condensed or cooled to a liquid form by a refrigeration system.

U.S. Pat. No. 1,918,100 shows a gas-gathering system which is basically a closed system in which vapors that collect in a storage tank are pumped into a secondary vapor storage tank partially filled with water and from the vapor storage tank are recaptured through a compression and condensing process to provide dry gas for other uses, such as combustion. The patent states as its primary objective the provision of a method and apparatus for maintaining a hydrocarbon gas at all times within the storage tanks above the liquid levels thereof with the specific end in view of preventing air from entering the tanks and mixing with the gases contained therein.

Regardless of the progress that has been made in the area of minimizing release of volatile materials into the atmosphere during the preparation of storage vessels for maintenance, there remains a need for improved devices and methods for purging volatile materials from a storage vessel. It is generally preferred to recover the volatile materials until the concentration of the vapors within the tank are below a specified regulatory limit.

### SUMMARY OF THE INVENTION

One embodiment of the present invention provides a method of removing vapor from a storage tank. One embodiment of the method comprises the step of introducing a stream of gas into the storage tank in a manner that causes mixing of the vapor within the tank, and the step of withdrawing a mixture of the vapor and the gas from the storage tank through an outlet port. The stream of gas is preferably introduced into the storage tank through a nozzle that increases the velocity of the gas. In one embodiment, the nozzle may have a fixed or a variable orientation that directs the stream of gas to flow into a region of the storage tank to prevent stagnation of the vapor in that region.

Another embodiment of the present invention provides a system for removing vapor from a storage tank. The system comprises a gas mover having an inlet in fluid communication with the storage tank to withdraw vapor from the storage tank, an abatement device in fluid communication with the outlet of the gas mover, a source of pressurized gas, and a nozzle in fluid communication with the source of pressurized gas, wherein the nozzle discharges to the storage tank to mix the vapor within the tank. Optionally, a motor or other actuator may be coupled to the nozzle to automatically vary the orientation of the nozzle. Where the abatement device is a gas cooler, the system may optionally include a recycle conduit to return gas and/or any uncondensed vapor to the storage tank, for example, through a nozzle.

### BRIEF DESCRIPTION OF THE DRAWINGS

FIG. 1 is a plan view of a vapor space within a storage tank showing channeling between an inlet port and an outlet port.

FIG. 2 is a side elevation view of a vapor space intermediate a floating roof assembly and a floor of a storage tank showing gravitational stratification of heavy vapors in regions below the inlet port and outlet port.

FIG. 3A is a plan view of a storage tank having a gas inlet nozzle oriented to introduce gas into the storage tank in a manner that causes mixing of the vapor within the tank.

FIG. 3B is a plan view of a storage tank having a manway cover comprising a gas inlet nozzle and an outlet port.

FIG. 4 is a schematic diagram of a man-way cover that comprises a vapor outlet port and a manipulatable nozzle for introducing a stream of gas to various portions of the storage tank.

FIG. 5 is a process diagram for condensing vapor withdrawn from the storage tank and introducing gas into the storage tank.

FIG. 6 is a process diagram for introducing gas into the storage tank and burning vapor withdrawn from the storage tank.

### DETAILED DESCRIPTION OF THE INVENTION

One embodiment of the invention provides a method of removing vapor from a storage tank. The method comprises introducing a stream of gas into the storage tank in a manner that causes mixing of the vapor within the tank, and withdrawing a mixture of the vapor and the gas from the storage tank through an outlet port.

The gas used to cause mixing of the vapor may be any gas that is compatible with the vapor and/or the liquid present in the storage tank, and with any downstream processing of the vapor or liquid that may occur subsequent to its removal from the storage tank. In one embodiment, the preferred gas is air. However, if the volatile vapor is reactive with oxygen in air, then an inert gas, such as nitrogen, may be used. The selected gas may be supplied under pressure from a compressed gas storage container or from a gas mover, such as a compressor or a blower. Other gases or vapors may be used for the purpose of mixing on the basis of their chemical compatibility with the vapor composition, cost and availability at the site of the storage tank. For example, steam may be used at sites where steam is economically available.

As used herein, the term “mixing” means to stir, agitate, or sweep so as to cause movement of the vapor. Mixing the vapor within the storage tank increases the rate of vapor removal rate by preventing channeling of the gas from an inlet port directly to an outlet port, reducing the degree of stagnation of the vapor in one or more region of the storage tank, reducing the degree of gravitational stratification of the vapor within the storage tank, or some combination of these. Mixing is also believed to have the effect of increasing the uniformity of vapor concentration throughout the storage tank.

Embodiments of the invention may include the use of a gas nozzle. As used herein, a nozzle is a generally convergent structure at the end of a gas conduit that accelerates a stream of gas being introduced into a storage tank. By increasing the velocity of the gas in a narrow stream, the stream of gas may flow from its point of introduction to remote regions of the storage tank and circulate gas and vapor throughout the tank. Furthermore, the gas nozzle may have a fixed or a variable orientation that introduces the stream of gas into a region of the storage tank to disturb the vapor and/or prevent stagnation of the vapor in that region. The orientation of the nozzle may be manually or automatically varied, such as through the periodic or continuous motion of a mechanical linkage or a motor. One useful orientation of the gas nozzle may introduce the stream of gas to flow along the wall of the storage tank, such as along the circumferential wall of a vertical cylindrical storage tank. Gradual changes in the angle of the wall may allow a circumferentially-directed gas stream to induce favorable vapor circulation throughout the storage tank.

In other embodiments, the stream of gas may be introduced at various positions of the storage tank. For example, if multiple ports available around the perimeter of a cylindrical storage tank, the stream of gas may be introduced at a point remote from the outlet used to withdraw the vapor/gas mixture. However, a storage tank may have a minimal number of ports and it may be desirable to use the fewest number of ports possible. Accordingly, the stream of gas may be introduced at a point immediately adjacent the outlet at which the vapor/gas mixture is withdrawn, such as, for example, providing a stream of gas inlet and a vapor/gas mixture outlet as side-by-side penetrations in a common man-way cover. When the stream of gas inlet is immediately adjacent the vapor/gas mixture outlet, it may be desirable to utilize a gas nozzle that directs the gas stream into the storage tank away from the outlet.

Another embodiment of the invention may include processing the withdrawn mixture of the vapor and the gas to abate emissions. Such processing may include, without limitation, recovery of the vapor, such as by cooling and condensing the vapor and collecting the condensate, or combustion of the vapor, such as by passing the vapor through a fuel-assisted flare and releasing the combustion byproducts into the atmosphere. A suitable condenser or refrigeration unit may be constructed as a shell and tube heat exchanger operating with a cooling fluid, such as, but not limited to, liquid nitrogen. The condenser should condense at least a portion of the vapor out of the vapor/gas mixture, but any uncondensed portion of the withdrawn mixture may be returned to the storage tank in the stream of gas used to cause mixing within the storage tank. In this manner, there is no or minimal loss of vapor from the system. Alternative processing units may include a filtration unit or an absorption unit, which may comprise a selectively absorbing solvent.

It may be preferable to periodically or continuously measure the concentration of the vapor in the withdrawn mixture, or to measure at least one component of the vapor. For example, in order to reduce the amount of fugitive emissions released to the atmosphere after a first phase of emissions abatement, environmental regulations may dictate that the storage tank not be opened to the atmosphere until the concentration of one or more components of the vapor has been reduced below a predetermined limit or target concentration. The regulatory limits for a particular volatile vapor composition are generally related to the impact of the vapor on health, safety and the environment. Storage tanks containing hydrocarbons, for example, may not be opened to the atmosphere until the hydrocarbon vapor concentration is below 34,000 parts per million (ppm).

Introducing a stream of gas into the storage tank in a manner that causes mixing of the vapor within the tank distributes the vapor more evenly throughout the storage tank, eliminating stagnant regions with higher than average concentrations of the vapor. Accordingly, samples of the vapor taken from the storage tank or from the outlet port will be more representative of the vapor concentration of the vapor throughout the storage tank. As a result, the vapor withdrawal will not be prematurely terminated on the basis of a vapor concentration measurement that falsely reads below the regulatory maximum due to unwanted gas channeling, gravitational stratification or other gas flow irregularity within the storage tank. Opening the storage tank to the atmosphere prematurely can result in a hazard to personal health, safety and the environment.

A storage tank may be any closed container for industrial storage of a volatile liquid. A storage tank may be fixed in place or adapted for transportation, such as a container car of a train or a barge. However, the storage tanks that will benefit the most from the methods and apparatus of the invention are those that prone to having regions of stagnant vapor. Regions of stagnant vapor may be the result of the storage tank dimensions, the position of ports available for purging the storage tank, and/or the nature of the volatile liquid contained within the tank.

Fixed storage tanks are often cylindrical in shape, perpendicular to the ground with flat bottoms, and a fixed or floating roof assembly. However, storage tanks are available in many shapes, including vertical cylindrical and horizontal cylindrical. The storage tank may have a flat bottom, conical bottom, sloped bottom or dished bottom. Large tanks tend to be vertical cylindrical, or have rounded corners to better withstand the hydrostatically induced pressure of the contained liquid. Some storage tanks, such as container tanks for storing liquids during transportation or liquid storage bullets, are designed to handle varying degrees of pressure.

A floating roof tank is a type of storage tank commonly used to store large quantities of volatile petroleum products, such as crude oil or gasoline. It comprises an open-topped cylindrical steel shell equipped with a roof assembly that floats on the surface of the liquid stored within the tank. Accordingly, the roof assembly rises and falls with the liquid level in the tank. Unlike a fixed roof tank, there is generally no substantial vapor space in a floating roof tank except for when the liquid level within the tank is minimal. In principle, this eliminates breathing losses and greatly reduces evaporative loss of the stored liquid. A rim seal system disposed between the tank shell and roof assembly may reduce evaporation around the rim of the floating roof assembly. The roof assembly may comprise a plurality of support legs extending down into the liquid such that, at minimal liquid levels, the roof assembly lands its legs on the floor of the tank and, with further reduction of the liquid level, a vapor space forms between the liquid surface and the underside of the roof assembly. Most of the liquid in the storage tank may be easily removed by pumping down to the level of the lowest suction port, but some amount of residual volatile liquid will often remain in the tank. The residual volatile liquid gradually evaporates and is withdrawn as a vapor mixed with the stream of gas introduced into the tank.

Another embodiment of the invention provides a system for removing vapor from a storage tank. The system may comprise, in one embodiment, a gas mover having an inlet, or suction, in fluid communication with the storage tank to withdraw vapor from the storage tank, an abatement device in fluid communication with the outlet, or discharge, of the gas mover, a source of pressurized gas, and a gas nozzle in fluid communication with the source of pressurized gas, wherein the gas nozzle discharges into the storage tank, preferably with an orientation that causes mixing of vapor within the tank. Optionally, a mechanical linkage or a motor may be coupled to the gas nozzle to enable the manual or automatic change of the orientation of the gas nozzle to promote mixing of the stream of gas with vapor in the tank. Where the abatement device is a gas cooler, the system may optionally include a recycle conduit to return gas and any uncondensed vapor to the storage tank through the gas nozzle or through a second gas nozzle.

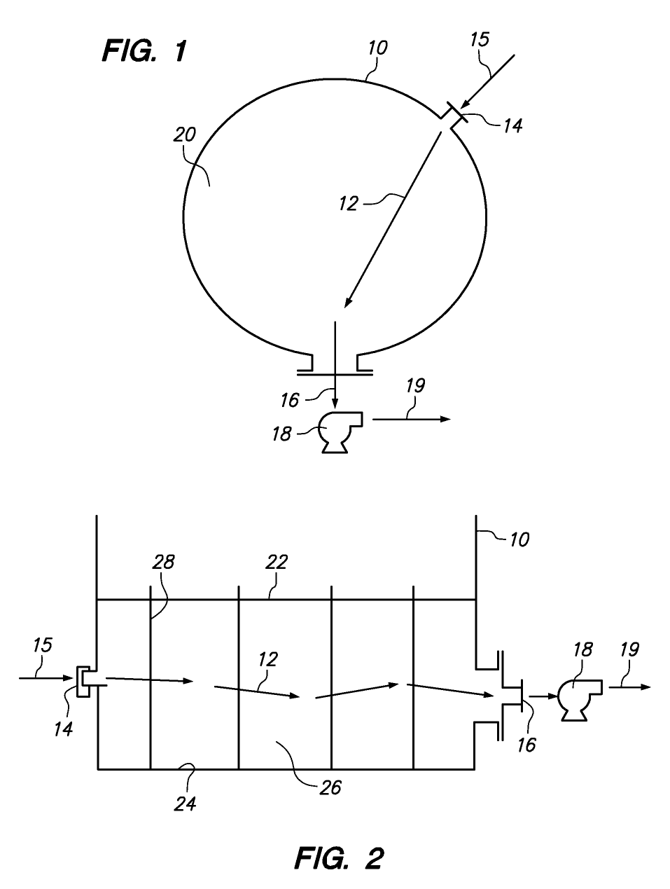

FIG. 1 is a plan view of a vapor space within a generally cylindrical storage tank 10 showing channeling along a path 12 between a stream of gas inlet port 14 and an outlet port 16. A supply of gas 15 is provided at the inlet port 14 in order to allow the withdrawal of vapor from the outlet port 16 by a gas mover 18 without pulling a substantial vacuum within the storage tank. However, differences in density and other fluid dynamics may allow channeling of the gas between the ports 14, 16 such that the concentration of vapor in the withdrawn vapor/gas mixture 19 is not representative of the vapor concentration throughout the storage tank. In particular, a stagnant region 20 of the storage tank 10 may contain substantially higher concentrations of the vapor than in the withdrawn mixture 19.

FIG. 2 is a side elevation view of a vapor space between a floating roof assembly 22 and floor 24 of a cylindrical storage tank 10 showing gravitational stratification of heavy vapors in a lower region 26 below the inlet port 14 and outlet port 16. The flow of gas 15 passes between the two ports 14, 16 leaving the concentrated vapors in the lower region 26 largely undisturbed. Although a floating roof assembly 22 usually eliminates a substantial vapor space by floating on the surface of the liquid stored within the tank, a vapor space may be created once the liquid has been removed from the tank so that the surface of the liquid within the tank resides below the level at which the floating roof assembly support legs 28 engage the floor 24 and thereby prevent the roof assembly 22 from following the descending surface of the liquid.

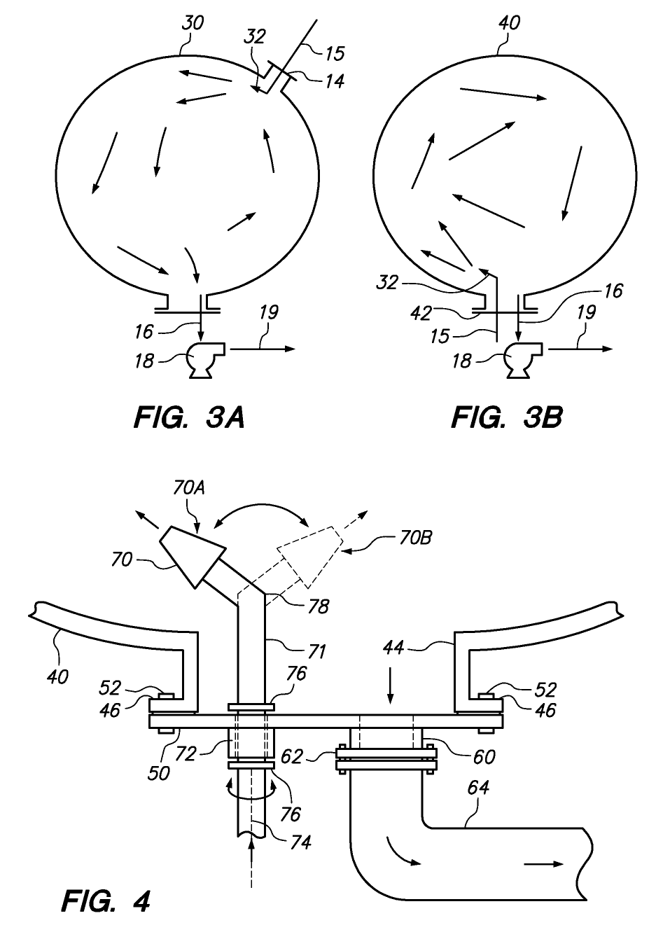

FIG. 3A is a plan view of a cylindrical storage tank 30 having a gas inlet nozzle 32 oriented to introduce a stream of gas 15 into the storage tank in a manner that causes mixing of the vapor within the tank. The arrows within the storage tank 30 illustrate the mixing of the vapor that may be induced within the tank as a result of the directed stream of gas emerging from the gas nozzle 32. As a result of the mixing action, the vapor concentration of the withdrawn mixture 19 is an accurate representation of the vapor concentration throughout the tank 30 and vapor may be withdrawn from the tank, using a given gas mover, at a greater rate than could be achieved in the absence of mixing.

FIG. 3B is a plan view of a cylindrical storage tank 40 having a man-way cover 42 comprising a gas nozzle 32 and an adjacent outlet port 16. Although the gas nozzle 32 is positioned immediately adjacent the outlet port 16, the gas nozzle is oriented to direct gas 15 into the storage tank in a manner that causes mixing of the vapor within the tank. The arrows within the storage tank 40 illustrate the mixing of the vapor that is induced within the tank as a result of the directed stream of gas emerging from the nozzle 32. As a result of the mixing action, the vapor concentration of the withdrawn mixture 19 is an accurate representation of the vapor concentration throughout the tank 30 and vapor may be withdrawn from the tank, using a given gas mover, at a greater rate.

FIG. 4 is a schematic diagram of a man-way cover 50 that comprises a vapor outlet port 60 and a rotatable gas nozzle 70 for variably introducing a stream of gas throughout the storage tank. In one embodiment, the man-way cover 50 may be secured to the man-way 44 of the tank 40 to replace a standard man-way cover that is installed while the tank is used to store a volume of liquid. The man-way cover 50 may be secured around its perimeter to a man-way flange 46 using bolts 52 or other fasteners, such as clamps, a hinge, a throw received into a jam, etc.

The vapor outlet port 60 formed in the man-way cover 50 may comprise a flange 62 for securing a hose, a tube or a pipe 64 that is fluidically coupled to the inlet of a gas mover (not shown) and a vapor abatement device, such as a condenser or a burner. The rotatable gas nozzle 70 may also secured to the man-way cover 50 with a sealed boot or bearing 72 that allows movement and/or rotation of the gas nozzle tube 71 about its axial centerline 74. A pair of collars 76 may be included so that the gas nozzle 70 will maintain an extension or a range of extension into the tank 40. By forming a bend 78 in the gas nozzle tube, rotation of the gas nozzle tube 71 about the axial centerline 74 causes the gas nozzle 70 to vary in direction. In particular, the orientation of the gas nozzle 70 will sweep between a first position 70A and a second position 70B. As shown in FIG. 4, the first position 70A directs a stream of gas generally to the left along the circumference of the storage tank 40, and position 70B directs the stream of gas to the right along the circumference of the storage tank 40. Positions of the gas nozzle 70 between the first and second positions 70A, 70B may cause the stream of gas to flow at different angles, including a generally upward direction and generally downward direction. The angle in the bend 78 determines the range of the gas nozzle positions that may be achievable by manipulating the gas nozzle tub 71, and may be altered depending upon the size and shape of the storage tank. Other nozzle configurations and mechanisms may also be utilized to achieve the same or different nozzle orientations and manipulations.

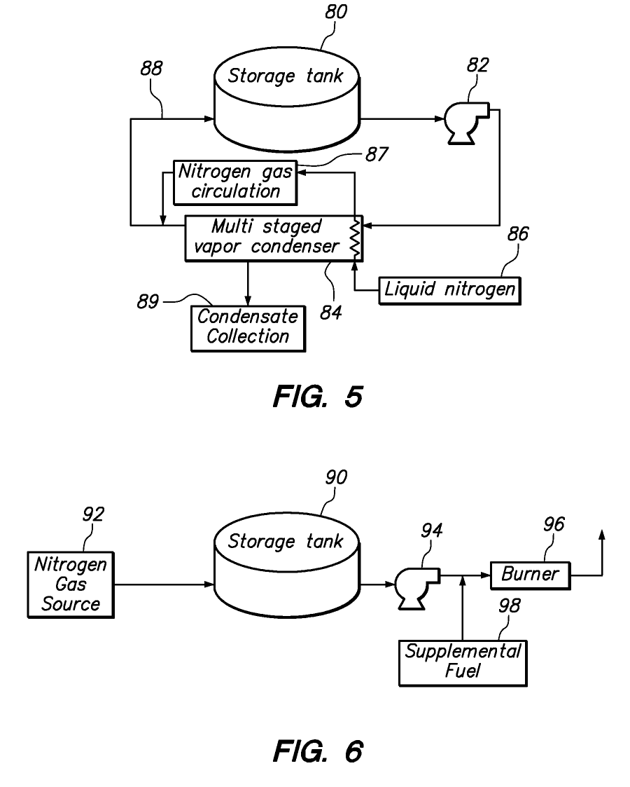

FIG. 5 is a process diagram for condensing vapor withdrawn from a storage tank 80 and introduces a stream of gas, for example, nitrogen gas, into the storage tank. A gas mover 82, such as a compressor or a blower, draws a gas/vapor mixture from the storage tank 80 and provides the mixture to the inlet of a vapor condenser 84. A source of liquid nitrogen 86, or other cooling fluid, may be provided to the vapor condenser 84 to cool the withdrawn vapor. For example, the vapor condenser 84 may be a shell and tube heat exchanger with the vapor flowing on the tube side and a cooling stream of liquid nitrogen flowing on the shell side. Liquid nitrogen is a suitable cooling fluid because it efficiently condenses a portion of the withdrawn vapor as it changes from a liquid to a gas. The nitrogen gas 87 may be collected and utilized in the stream of gas 88 that is introduced into the storage tank 80 through a gas nozzle to cause mixing. The condensed vapor is collected in a container 89, and may typically be recovered and utilized as a valuable product rather than being discarded. Furthermore, any uncondensed vapor may also be returned to the storage tank 80 in stream 88. As a result, this process removes vapor from the storage tank without the release of fugitive emissions to the environment.

FIG. 6 is a process diagram for introducing gas, for example, nitrogen gas, into the storage tank 90 and burning vapor withdrawn from the storage tank. A source of nitrogen gas 92 may be introduced into the storage tank 90 in a manner that causes mixing of the vapor within the tank. The gas mover 94 draws a gas/vapor mixture out of the storage tank 90 and provides the mixture to the inlet of a burner 96. Optionally, a supplemental fuel 98 may be provided to the burner along with the gas/vapor mixture to improve combustion and/or thermal oxidation of the vapor. The combustion products of the burner are generally released into the atmosphere, and are less harmful as compared to the release of the unprocessed vapor.

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. For example, the phrase “a heat exchanger comprising two sides” should be read to describe a heat exchanger having two or more sides. The terms “at least one” and “one or more” are used interchangeably. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention.

It should be understood from the foregoing description that various modifications and changes may be made in the preferred embodiments of the present invention without departing from its true spirit. The foregoing description is provided for the purpose of illustration only and should not be construed in a limiting sense. Only the language of the following claims should limit the scope of this invention.

What is claimed is:

1. A method of removing vapor from a storage tank, comprising:
introducing a stream of gas into the storage tank in a manner that causes mixing of the vapor within the tank; and
withdrawing a mixture of the vapor and the gas from the storage tank through an outlet port.

2. The method of claim 1, wherein the stream of gas is introduced into the storage tank through a gas nozzle.

3. The method of claim 2, further comprising:
orienting the gas nozzle to introduce the stream of gas to flow along the circumference of the storage tank.

4. The method of claim 2, further comprising:
automatically varying the orientation of the gas nozzle.

5. The method of claim 2, further comprising:
changing the orientation of the gas nozzle to cause the stream of gas to sweep through the storage tank.

6. The method of claim 1, wherein the stream of gas is introduced intermittently.

7. The method of claim 1, wherein the mixing prevents channeling of the gas from an inlet port directly to an outlet port.

8. The method of claim 1, wherein the mixing reduces the degree of stagnation of the vapor in one or more regions of the storage tank.

9. The method of claim 1, wherein the mixing reduces the degree of gravitational stratification of the vapor within the storage tank.

10. The method of claim 1, wherein the mixing increases the uniformity of vapor concentration throughout the storage tank.

11. The method of claim 1, further comprising:
processing the withdrawn mixture of the vapor and the gas to abate environmental emissions.

12. The method of claim 11, wherein the step of processing the withdrawn mixture comprises condensing at least a portion of the vapor out of the mixture.

13. The method of claim 12, further comprising:
returning an uncondensed portion of the withdrawn mixture to the storage tank in the stream of gas to cause mixing.

14. The method of claim 1, further comprising:
burning the mixture; and
releasing byproducts of the burning to the atmosphere.

15. The method of claim 1, wherein the storage tank comprises a floating roof assembly comprising one or more legs to support the roof assembly above a floor of the storage tank.

16. The method of claim 1, wherein the storage tank contains at least a residual amount of a volatile liquid.

17. The method of claim 1, further comprising:
measuring the concentration of at least one component of the vapor in the withdrawn mixture.

18. The method of claim 17, further comprising:
continuing to withdraw the mixture of the vapor and the gas until the vapor concentration in the storage tank is below a target concentration; and then
opening the storage tank to the atmosphere.

19. The method of claim 1, wherein the stream of gas is obtained from a compressed gas storage container.

20. A system for removing vapor from a storage tank comprising:
a gas mover having an inlet in fluid communication with the storage tank to withdraw vapor from the storage tank;
an abatement device in fluid communication with the outlet of the gas mover;
a source of pressurized gas; and
a gas nozzle in fluid communication with the source of pressurized gas, the gas nozzle discharging into the storage tank with an orientation that causes mixing of the vapor within the tank.

21. The system of claim 20, wherein the source of pressurized gas is a compressed gas storage container.

22. The system of claim 20, wherein the abatement device is a gas cooler.

23. The system of claim 22, further comprising:
a recycle conduit to return gas and any uncondensed vapor from the gas cooler to the storage tank through the gas nozzle.

24. The system of claim 20, wherein the abatement device is a burner.

25. The system of claim 19, further comprising:
a motor coupled to the gas nozzle to automatically manipulate the orientation of the gas nozzle.
